(19) United States
(12) Patent Application Publication
(10) Pub. No.: US 2005/0234887 A1
(43) Pub. Date: Oct. 20, 2005

(54) Code retrieval method and code retrieval apparatus

(75) Inventor: Yoshikatsu Harako, Aomori (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/955,655

(22) Filed: Sep. 30, 2004

(30) Foreign Application Priority Data
Apr. 15, 2004 (JP) 2004-119876

(51) Int. Cl. G06F 17/30

(52) U.S. Cl. 707/3

(57) ABSTRACT

The present invention aims at automatically retrieving the code related to a retrieval source code from a program. A similarity retrieval tool determines the abstraction level of a retrieval condition based on the modification management information for managing modification contents of the program and the system structure information showing a structure of the program. Furthermore, it abstracts a retrieval target program and the retrieval source code. The tool compares the abstracted retrieval target program and retrieval source code and calculates similarity ratios in line units. The tool outputs the calculated similarity ratios and the corresponding code as retrieval results.

### BACKGROUND OF THE INVENTION

1. Field of the Invention

The present invention relates to a code retrieval method of retrieving the code related to a retrieval source code from a target program, a computer data signal offering a code retrieval program and a code retrieval apparatus.

2. Description of the Related Art

In the development of a program, a new program is prepared by copying a prepared source code, or changing or adding a part of the prepared source code.

In such program development, in the case where a problem occurs in a part of a source code or measures to fix a bug, etc. are taken, the influence covers the copied part so that all the copied codes (clone codes) must be modified.

Generally, in the case where a source code is modified for the above-mentioned reason, a modification is added by retrieving the corresponding clone code using manual character string retrieval, etc.

In a target program, in the case where a change is added to the original source code, it is difficult to determine whether the present code is original or copied. Therefore, the copied code is sometimes overlooked. Furthermore, in the case where a program is developed by a plurality of developers and one developer develops a program using the program developed by another developer, it is not recognized that the source code is copied so that the copied codes may be left unchecked.

As the method of analyzing a source program, a method of automatically extracting an item name, a condition, etc. in the source program is described in, for example, a patent literature 1.

In addition, in a patent literature 2, a technology of extracting information in which specification information, etc. are abstracted and automatically analyzing a program using a graph method is described.

The invention of the patent literature 1 automatically extracts the item name, the conditional expression of a source program but it does not retrieve a copied source code from a specified program.
[Patent literature 1] Japan Patent No.3377836
[Patent literature 2] Japan Patent Application Publication No. 7-56731

### SUMMARY OF THE INVENTION

The subject of the present invention is to automatically retrieve the code related to a retrieval source code from a program.

The present invention offers a code retrieval method of retrieving the code related to a retrieval source code from a retrieval target program. The present invention determines the abstraction level of a retrieval condition based on at least either modification contents for the retrieval source code or system structure information about the system structure of a program including the retrieval source code. Then, it abstracts the retrieval target program and the retrieval source code based on the determined abstraction level. Furthermore, it compares the abstracted retrieval target program and retrieval source code, thereby calculating a similarity degree of the codes and outputs a code having a high similarity degree in the retrieval target program.

According to the present invention, by comparing the abstracted retrieval target program and retrieval source code based on the modification contents or the system structure information and by calculating the similarity degree of the two, a retrieval source code that exists in the retrieval target program and the similar code can be retrieved. With this, even in the case where a part of codes is changed in the retrieval target program, all the changed codes can be retrieved. Since a similar code is automatically retrieved, variations in retrieval accuracy caused by the different skills of persons who retrieve codes does not occur, which is different from a method of retrieving codes by manually inputting a retrieval character string.

According to another preferred embodiment of the present invention, when an abstraction level is determined, it is determined by stored information or inputted information which one of three changes such as a change of an item name or a variable name, a change other than a condition of a command and a change of a condition of a command, the modification contents for a retrieval source code correspond to, thereby determining an abstraction level based on the determination results.

According to this structure, a retrieval condition can be automatically set based on the abstraction level corresponding to the modification contents so that the proper retrieval suitable for the modification contents can be implemented. In this way, the aimed retrieval accuracy of a clone code can be enhanced and the possibility of retrieving unrelated codes can be decreased.

According to another preferred embodiment of the present invention, when an abstraction level is determined, the abstraction level is determined based on modification management information about the modification contents of a retrieval source code and system structure information about the system structure of a program including the retrieval source code.

According to this structure, by determining an abstraction level based on the modification contents and the system structure information, more suitable abstraction level can be determined so that proper retrieval can be implemented in accordance with an actual condition.

According to another preferred embodiment, when an abstraction level is determined, the abstraction level is determined based on information about a programming method of preparing the program including a retrieval source code and information about a position on the hierarchy in a system structure of the retrieval source code.

According to this structure, an abstraction degree of the retrieval source code can be determined by determining which system structure the program has as a characteristic, for example, the program has whether a system structure in which the abstraction degree of the program becomes higher as a hierarchy becomes higher or a system structure in which the abstraction degree of the program becomes lower as a hierarchy becomes lower and further by determining on which hierarchy the retrieval source code exists.

Therefore, the abstraction level suitable for an abstraction degree of the retrieval source code can be set so that the retrieval accuracy can be further enhanced.

A code retrieval apparatus of the present invention retrieves the code related to a retrieval source code from a retrieval target program. This apparatus comprises an abstraction level determining unit determining the abstraction level of a retrieval condition based on at least either modification contents for the retrieval source code or system structure information about a system structure of a program including the retrieval source code; an abstracting unit abstracting the retrieval target program and the retrieval source code based on the abstraction level determined by the abstraction level determining unit; a similarity degree calculating unit comparing the retrieval target program and the retrieval source code that are abstracted by the abstracting unit, thereby calculating a similarity degree of the codes; and an outputting unit outputting a code having a high similarity degree calculated by the similarity degree calculating unit.

According to this invention, by abstracting the retrieval target program and the retrieval source code based on the modification contents for the retrieval source code or the system structure information and by calculating the similarity degree of the two, a code highly related to the retrieval source code that exists in the retrieval target program can be retrieved. Thus, even in the case where a part of codes is changed in the retrieval target program, all the changed codes can be retrieved. Furthermore, since similar codes are automatically retrieved, no variation in retrieval accuracy caused by skills of persons who retrieve codes does not occur, which is different from a method of manually inputting a retrieval character string.

The outputting unit displays, for example, the similarity degree between a corresponding code of the retrieval target program and a retrieval source code of the corresponding code.

According to another preferred embodiment of a code retrieval apparatus of the present invention, the abstracting unit comprises a dividing unit dividing the retrieval target program in block units. The similarity degree calculating unit compares the lines of a block including the retrieval source codes and the lines of a block of the retrieval target programs. The similarity degree calculating unit also compares lines which do not match in word units, thereby calculating similarity degrees of respective lines and a similarity degree in block units.

With this structure, user can easily determine whether or not the retrieved code is copied from a retrieval source code, using the similarity degrees in line units and in block units.

According to another preferred embodiment of a code retrieval apparatus of the present invention, the abstraction level determining unit determines whether or not a retrieval source code is the common module that is commonly used in a program and sets the abstraction level low in the case where the retrieval source code is the common module.

With this structure, in the case where the retrieval source code is a common module that is commonly used in a program, it is determined that the retrieval source code is abstracted to be used commonly and accordingly the code can be abstracted at a level suitable for an abstraction degree of the retrieval source code.

According to another preferred embodiment of a code retrieval apparatus of the present invention, the abstraction level determining unit determines whether or not a program for preparing the retrieval source code is a structured program, determines whether a hierarchy on which the retrieval source code exists is a high-level hierarchy or a low-level hierarchy and sets the abstraction level of a retrieval condition high in the case where the retrieval source code exists on the high-level hierarchy.

With this structure, in the case where a program of the retrieval source code is a structured program, an abstraction level suitable for the retrieval source code can be set from a position of a hierarchy, on which the retrieval source code exists, using a system structure of the program.

### BRIEF DESCRIPTION OF THE DRAWINGS

FIG. 1 shows a basic configuration of a preferred embodiment of the present invention;

FIG. 2 shows a configuration of the retrieval tool of a preferred embodiment of the present invention;

FIG. 3 shows a flowchart of abstraction level determination processings;

FIG. 4 shows a modification management information table;

FIG. 5 shows a system structure information table;

FIG. 6 shows system structures of a structured program and an object-orientated program;

FIG. 7 shows a flowchart of abstraction level selecting processings based on the system structure information;

FIG. 8 shows an example of abstraction processings;

FIG. 9 shows a flowchart of processings of dividing a structured program into blocks;

FIG. 10 explains a process of dividing a structured program into blocks;

FIG. 11 explains a process of dividing an object-oriented program into blocks;

FIG. 12 shows a flowchart of code comparison processings in block units;

FIG. 13 explains the comparison of codes in block units;

FIG. 14 shows a flowchart of similarity ratio calculating processings;

FIG. 15 shows a similarity ratio for each abstraction level;

FIG. 16 shows one example of similarity ratio calculation; and

FIG. 17 shows a hardware structure.

### DESCRIPTION OF THE PREFERRED EMBODIMENTS

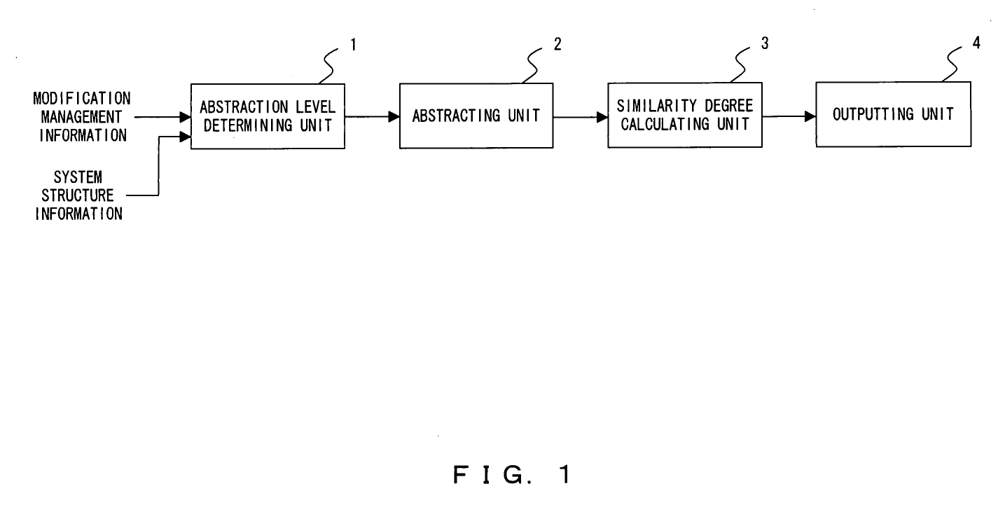

The following is the explanation of the preferred embodiments of the present invention in reference to the drawings. FIG. 1 shows a basic configuration of a code retrieval apparatus of the present invention.

The code retrieval apparatus related to the present invention retrieves the code related to a retrieval source code from a retrieval target program. It comprises an abstraction level determining unit 1 determining an abstraction level of a retrieval condition based on at least either modification contents for a retrieval source code or system structure information about the system structure of a program including the retrieval source code; an abstracting unit 2 abstracting the retrieval target program and the retrieval source code based on the abstraction level determined by the abstraction level determining unit 1; a similarity degree calculating unit 3 comparing the retrieval target program and the retrieval source code that are abstracted by the abstracting unit 2 and calculating a similarity degree of the codes; and an outputting unit 4 outputting a code having a high similarity degree calculated by the similarity degree calculating unit 3.

According to this configuration, by abstracting the retrieval target program and the retrieval source code based on either the modification contents for the retrieval source code or the system structure information and by calculating the similarity degree of the two, a code highly related to the retrieval source code that exists in the retrieval target program can be retrieved. Thus, even in the case where a part of codes is changed in the retrieval target program, all the changed codes can be retrieved. Furthermore, since similar codes are automatically retrieved, no variation in retrieval accuracy caused by skills of persons who retrieve codes does not occur, which is different from a method of manually inputting a retrieval character string.

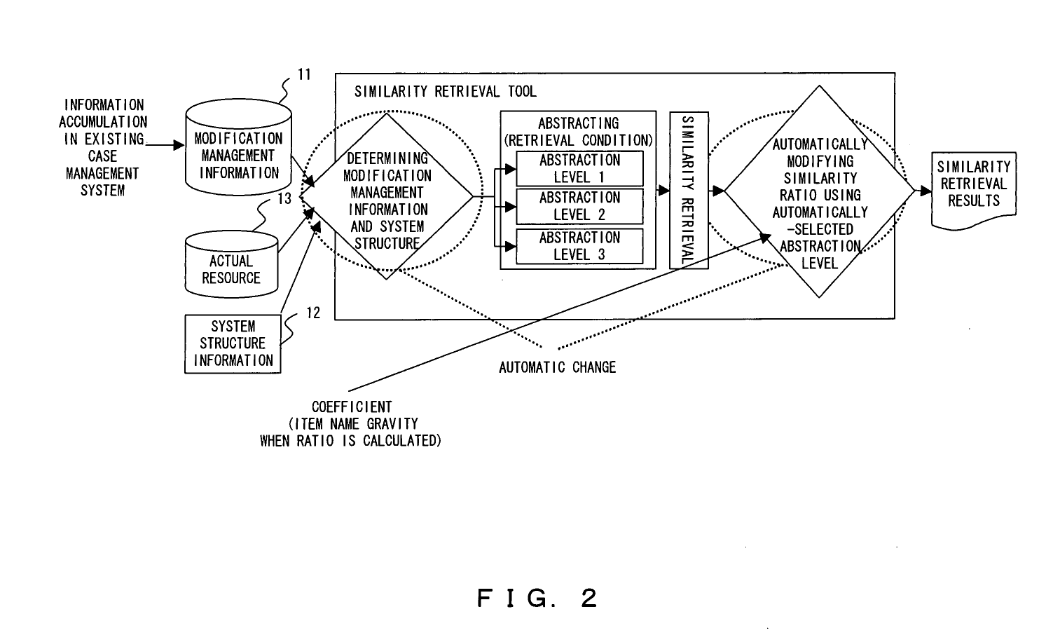

FIG. 2 shows the configuration of a similarity retrieval tool of the preferred embodiment. The similarity retrieval tool is a program to be implemented on a code retrieval apparatus (personal computer, exclusive apparatus, etc.), and has a function of retrieving a clone code that is copied from the retrieval source code from the retrieval target program and a function of displaying the similarity.

The retrieval tool determines the abstraction level of a retrieval condition based on modification management information 11 for managing modification contents of a program and system structure information 12 about the structure of a program. Meanwhile, the tool may check on which hierarchy of the system structure the modified code exists using an actual resource 13 storing a reference source program (modified program), thereby determining the abstraction level based on the information (information corresponding to the system structure information 12).

The abstraction level of a retrieval condition is the information of determining how much an item name, an command, the execution condition of the command etc. that are described in a retrieval source code and a retrieval target program, are abstracted.

When the abstraction level is determined, the abstracted retrieval target program and a retrieval source code (code before modification) are compared and a similarity ratio (similarity degree) is calculated. Furthermore, a coefficient in accordance with the abstraction level is multiplied by a matching number and the similarity ratio is automatically modified. Then, the corresponding code together with the calculated similarity ratio is outputted as retrieval results.

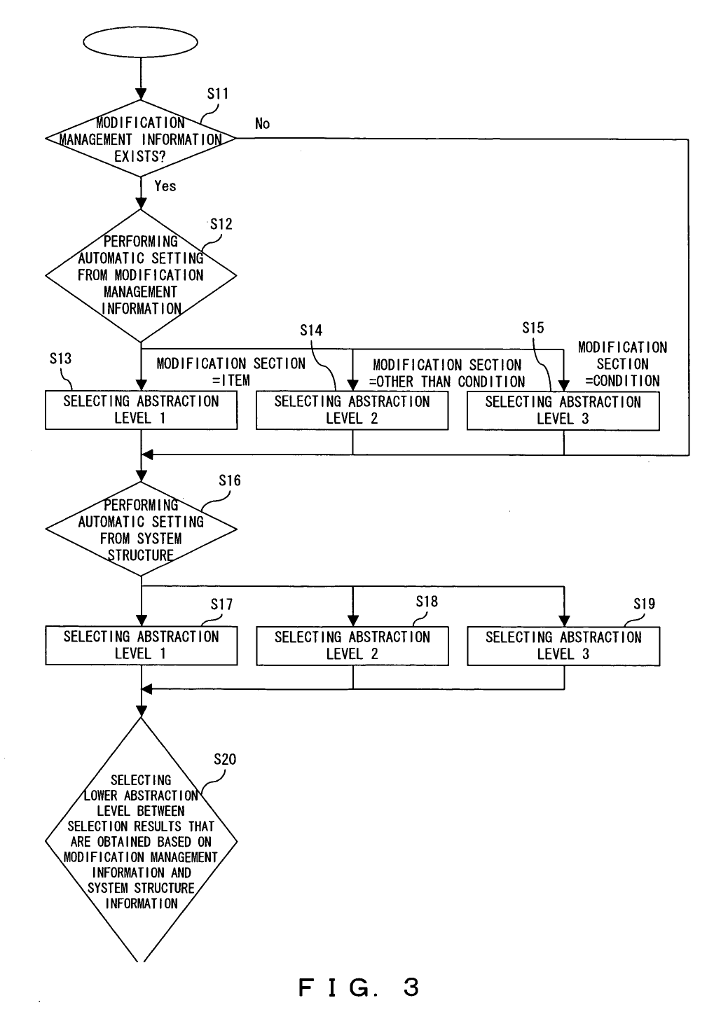

Then, the abstraction level determination processing is explained in reference to the flowchart of FIG. 3. The following processings are implemented by the CPU of a computer for implementing the similarity retrieval tool.

First, it is determined whether or not the modification management information 11 exists (FIG. 3, S11). In the case where the modification management information 11 exists, a process advances to step S12 and the abstraction level is determined on the basis of the modification management information 11.

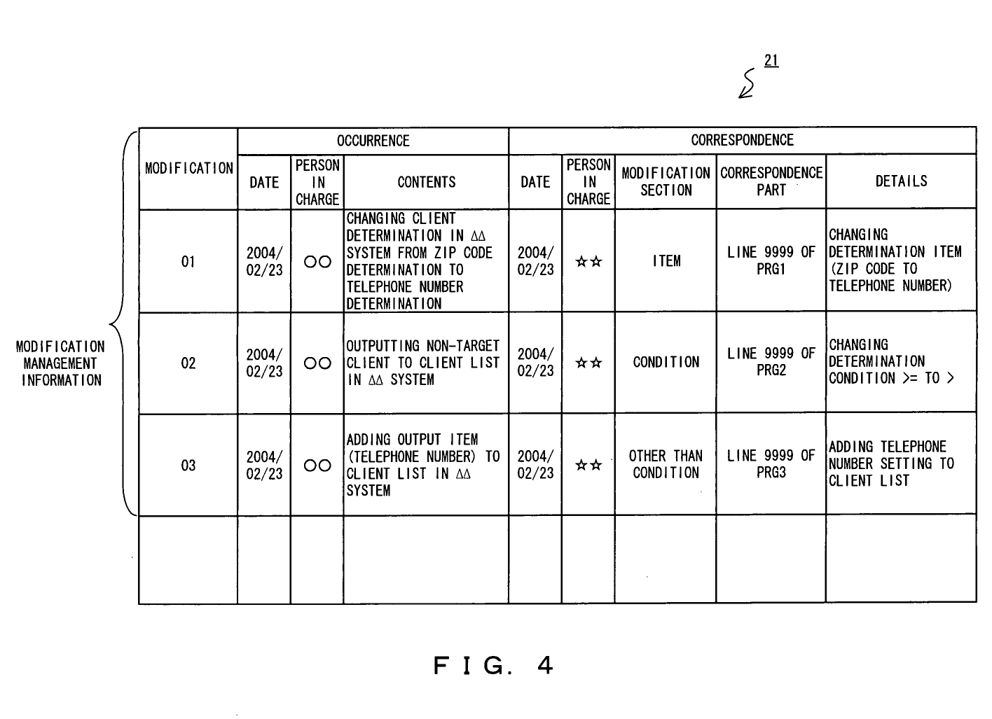

Here, the modification management information 11 is explained in reference to FIG. 4. FIG. 4 is a table showing the data that is stored in a modification management information table 21.

In the modification management information table 21, the modification management information 11 that shows which modification is added to the program for each program is stored. As shown in FIG. 4, as the modification management information 11, the date at the time a specification change or an obstacle occurs, a person in charge, occurrence contents, the date at the time a modification is made, a person in charge, a modification section showing a section corresponding to modification contents, correspondence part (information specifying a modification line of a program), the details of modification contents, etc. are recorded. The person who changes the specification of a program, detects the obstacle of a program and modifies a program, inputs the modification management information 11.

For example, in the case where the item name of a program is changed, an “item” is set as a modification section. In the case where the execution condition of a command is changed, a “condition” is set as a modification section. In the case where the part other than the execution condition of a command is changed, “other than condition” is set as a modification section.

The abstraction level of a retrieval condition is automatically set on the basis of the modification section of the above-mentioned modification management information 11. For example, in the case where a modification section of the modification management information 11 is an “item”, a process advances to step S13 of FIG. 3 and an abstraction level 1 is selected. Furthermore, in the case where the modification section is “other than condition”, a process advances to step S14 and an abstraction level 2 is selected. In addition, in the case where the modification section is a “condition”, an abstraction level 3 is selected.

As for the abstraction levels 1 to 3, the degree of abstraction becomes high in the order of level 1, level 2 and level 3. For example, in the case where an item name is modified and an “item” is set as a modification section, the item name is an important retrieval point so that the item name is not abstracted and the item name itself needs to be retrieved. As for the abstraction level in this case, the level 1 that is the lowest degree of abstraction is set.

Furthermore, in the case where the part other than the execution condition of a command is modified and “other than condition” is set as a modification section, an item name or a variable name is abstracted since a command sequence other than a condition is the key of retrieval. In this case, the abstraction level 2 that is the second degree of abstraction is set as an abstraction level.

In the case where the execution condition of a command is modified and a “condition” is set as a modification section, codes having different conditional statements but having the same contents need to be retrieved so that a condition is abstracted and such codes are retrieved. As an abstraction level in this case, the level 3 with the highest degree of abstraction is selected.

Then, the abstraction levels 1 to 3 are selected on the basis of the system structure information 12 (FIG. 3, S16 to S19)

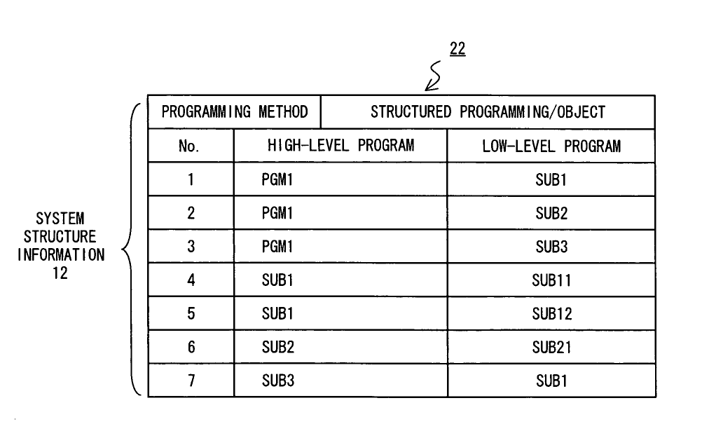

The system structure information 12 is stored in a system structure information table 22 as shown in FIG. 5. In the system structure information table 22, information showing by which programming method the program is prepared, for example, information showing whether the program is prepared by a structured programming method or by an object-orientated programming method, etc. and information about the hierarchy structure of a program are recorded. As the information showing a hierarchy structure, a high-level program name and a low-level program name are registered while corresponded to each other.

In the example of FIG. 5, it is regulated that programs SUB1, SUB2 and SUB3 exist in the subordinate position of a program PGM1, programs SUB11 and SUB12 exist in the subordinate position of the program SUB1, a program SUB21 exists in the subordinate position of the program SUB2 and the program SUB1 exists in the subordinate position of the program SUB3.

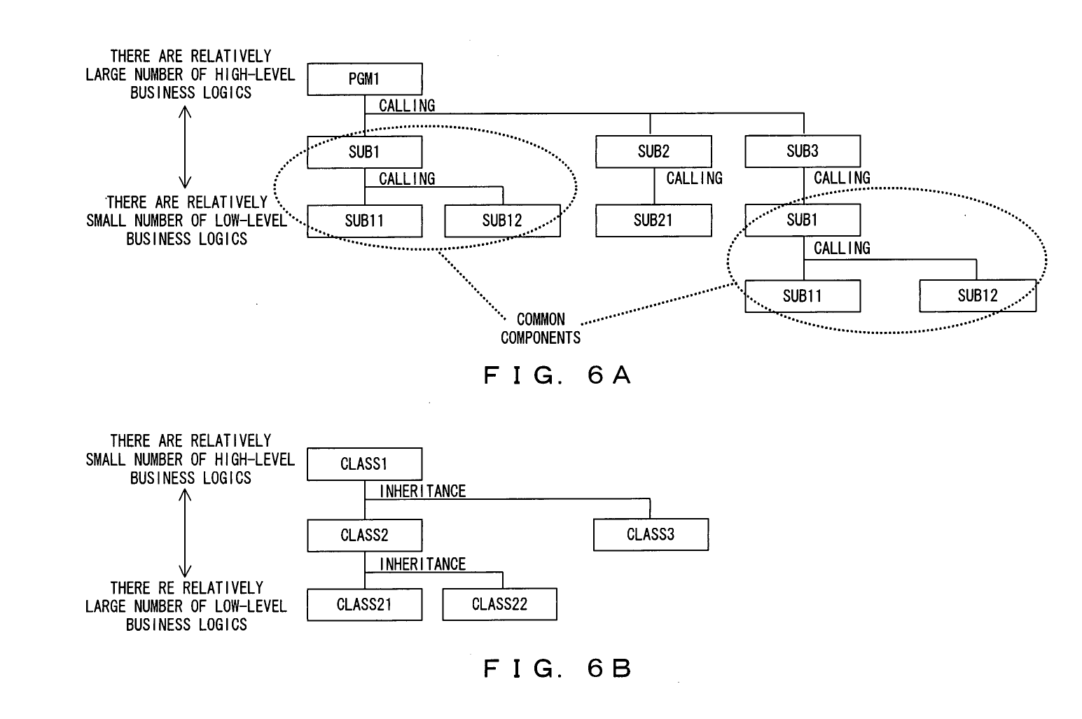

The system structure information 12 of FIG. 5 corresponds to the structured program of FIG. 6A. Accordingly, it is understood from the above-mentioned fact that the programs SUB1, SUB11 and SUB12 are common modules that are used in a plurality of parts. Since these common modules are abstracted to be used without depending on the processing contents, an abstraction level for the common modules is set at a low level when an abstraction level is selected.

If the selection of an abstraction level based on the system structure information 12 terminates, a process advances to step S20 of FIG. 3 and a lower abstraction level is selected from among abstraction level selection results that are obtained based on the modification management information 11 and the system structure information 12. Meanwhile, the abstraction level may be determined based on either the modification management information 11 or the system structure information 12.

Here, the system structure of a structured program and an object-oriented program are explained in reference to FIG. 6

The program prepared by the technique of structured programming shown in FIG. 6A has a system structure in which the program of a high-level hierarchy has a comparatively large number of business logics related to concrete processing contents while the program of a low-level hierarchy has a comparatively small number of business logics.

The programs SUB1, SUB11 and SUB12 of FIG. 6A are common modules that emerge several times on a system structure and are prepared to be implemented irrespective of processing contents. As for the common module that is used as a common component, the abstraction level 1 with the lowest abstraction degree is selected at the abstraction level selection processing that is described later since the programming contents are already abstracted.

In addition, the abstracted programming is performed for the program of the lowest-level hierarchy of the structured program. In the case where the program is compared with a common module, since the concrete expression such as an item name, etc. exists, the abstraction level 2 with the second abstraction degree is selected in an abstraction level selection processing that is described later.

As for the programs between a high-level hierarchy and an intermediate-level hierarchy, since the more concrete programming is performed, the abstraction level 3 with the highest abstraction degree is selected in an abstraction level selection processing that is described later.

The program prepared by an object-oriented programming method as shown in FIG. 6B has a system structure in which the program of a high-level hierarchy has a comparatively small number of business logics related to concrete processing contents while the program of a low-level hierarchy has a comparatively large number of business logics.

As for the program of a high-level hierarchy, since abstraction programming is performed, the abstraction level 2 is selected in an abstraction level selection processing that is described later.

As for the programs between an intermediate-level hierarchy and the lowest-level hierarchy, since the concrete programming is performed, the abstraction level 3 with the highest abstraction degree is selected in an abstraction level selection processing that is described later.

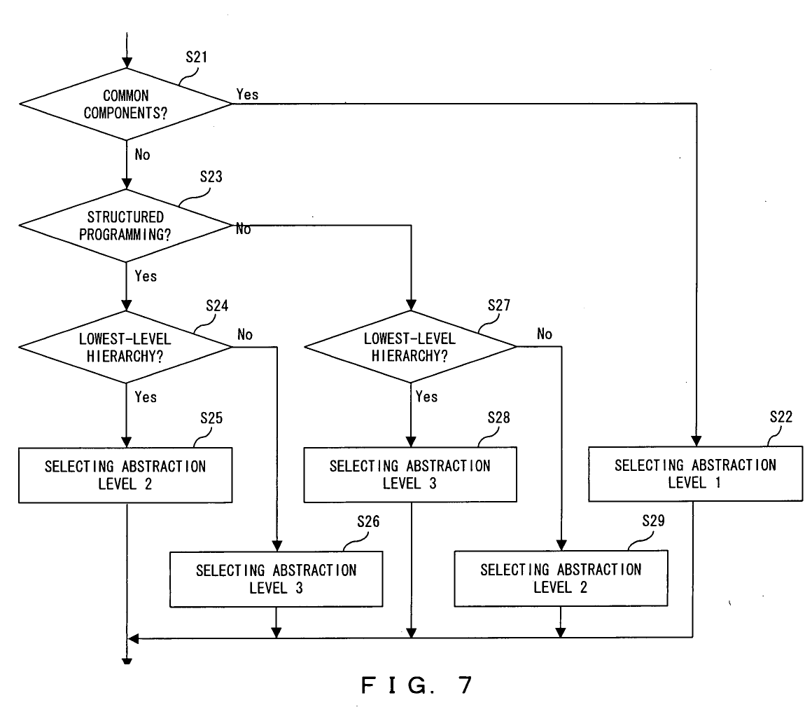

FIG. 7 shows the more detailed flowchart of an abstraction level selection processing based on the system structure in steps S16 to S19 of FIG. 3.

First of all, it is determined by the system structure information 12 whether or not the program to which a retrieval source code belongs is a commonly-used module, in other words, a common component (S21 of FIG. 7).

In the case where it is determined that the program is a common component that is commonly used in the whole program (S21, YES), a process advances to step S22 and the abstraction level 1 with the lowest abstraction degree is selected.

This is because if the program is a common component, the description of the program is abstracted so as to be implemented without depending on processing contents. Therefore, the program need not be further abstracted.

It is determined whether or not the information regarding a programming method of the system structure information table 22 indicates structured programming (S23).

In the case where the program is prepared by the structured programming (S23, YES), a process advances to step S24. In this step, it is determined whether or not the program is a program of the lowest-level hierarchy referring to the system structure information table 22.

In the case of a program of the lowest-level hierarchy (S24, YES), a process advances to step S25 and the abstraction level 2 is selected.

In the case where the program is not a program of the lowest-level hierarchy in step S24 (S24, NO), a process advances to step S26 and the abstraction level 3 is selected.

In the case where it is determined by the system structure information 12 that the program is a structured program and a program of the lowest-level hierarchy according to the above-mentioned processing, the abstraction level 2 with the second abstraction degree is selected since the description of the program is abstracted as explained in FIG. 3. In addition, in the case where it is determined that the program is a program between the high-level hierarchy and the intermediate-level hierarchy, the abstraction level 3 is selected since the program is further concretely described. Consequently, the program must be further abstracted.

In the case where it is determined that the program is not structured programming (S23, NO), a process advances to step S27 and it is determined whether or not the program is the lowest-level hierarchy.

In the case where it is determined that the program is the lowest-level hierarchy (S27, YES), a process advances to step S28 and the abstraction level 3 is selected. In the case where it is determined that the program is not the lowest-level hierarchy (S27, NO), a process advances to step S29 and the abstraction level 2 is selected.

According to the above-mentioned processing, in the case where it is determined using the system structure information 12 that the program is an object-oriented program and the lowest-level hierarchy, the program must be further abstracted so that the abstraction level 3 is selected since the program is concretely described as explained in FIG. 6. In the case where it is determined that the program is a program of a high-level hierarchy, the abstraction level 2 with the second abstraction degree is selected since the program is abstractly described.

Once an abstraction level is determined as described above, a retrieval source code and a retrieval target program are abstracted based on the selected abstraction level.

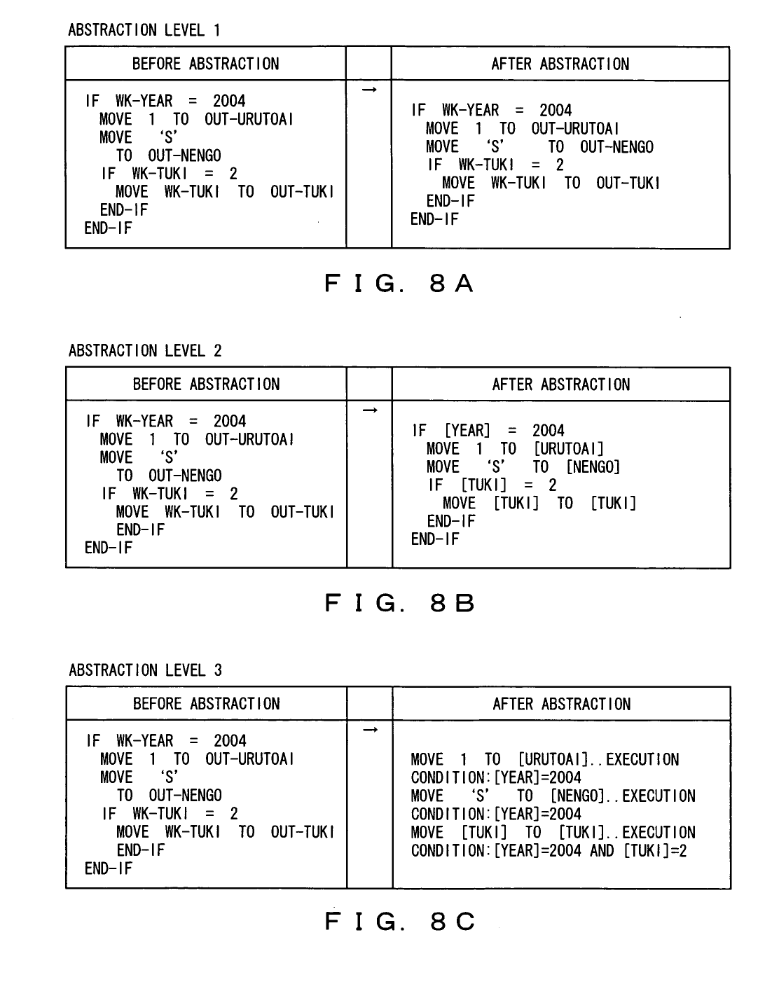

FIG. 8 shows examples of cases where the same program is abstracted using the abstraction levels 1, 2 and 3.

Firstly, the case where a before-abstraction program shown on the left side of FIG. 8A is abstracted is explained.

At the abstraction level 1, an item name/variable name is not abstracted and commands are only normalized (removal of halfway linefeed of sentence and removal of omission form). The abstraction level 1 is applied to the case where an item name, a variable name and a command sequence are retrieved.

“MOVE ‘S’” and “TO OUT-NENGO” that are described over two lines from the third line to the fourth line of the program before abstraction are combined to one abstracted line “MOVE ‘S’ TO OUT-NENGO” as shown on the right side of FIG. 8A. In this case, the item name and the variable name are not abstracted.

Then, the case where the program on the left side of FIG. 8B (same as the program of FIG. 8A) is abstracted at the abstraction level 2 is explained.

At the abstraction level 2, the item name and the variable name are abstracted, in addition to the abstraction of the abstraction level 1. This abstraction level 2 is applied to the case where a sequence of commands is retrieved other than the command execution conditions.

An item name “WK-YEAR” described as “IF WK-YEAR=2004” in the first line of the program before abstraction is abstracted to an item name [YEAR] as shown on the right side of FIG. 8B. Furthermore, an item name described as “OUT-URUTOAI” in the second line of the program before abstraction is abstracted to an item name [URUTOAI]. Similarly, “OUT-NENGO” that is an item name in the fourth line is abstracted to [NENGO] and “WK-TUKI” and “OUT-TUKI” that are item names in the fifth and sixth lines are abstracted to an item name [TUKI].

In the case where a part of item names of the copied retrieval source code is changed in a retrieval target program, a code related to the retrieval source code (cord with high possibility of being copied) can be retrieved by abstracting the item name and the variable name in this way.

Then, the case where the program on the left side of FIG. 8C (same as the above-mentioned program) is abstracted at the abstraction level 3 is explained.

At the abstraction level 3, the description of a conditional statement is abstracted in addition to the abstraction of the abstraction level 2. This abstraction level 3 is applied to the case where commands with the differently-described conditional statements but the same contents are retrieved.

A conditional statement “IF WK-YEAR=2004” in the first line of a before-abstraction program of FIG. 8C is abstracted to “execution condition: [YEAR]=2004” as shown on the right side of FIG. 8C and this is described after command sentences “MOVE 1 TO [URUTOAI]” and “MOVE ‘S’ [NENGO]” as an execution condition. Meanwhile, an item name of the command sentence is simultaneously abstracted.

Similarly, “IF WK-TUKI=2” that is the conditional statement in the fifth line is abstracted to “execution condition: [YEAR]=2004” as shown on the right side of FIG. 8C and this abstracted statement is described after “MOVE [TUKI] TO [TUKI]” that is a MOVE command as an execution condition.

All the codes related to a retrieval source code can be retrieved in a retrieval target program by abstracting a conditional statement as the execution condition of each command in this way in the case where the description form of the retrieval source code and that of the conditional statement are different, a change of the loop of an execution condition is carried out, etc.

Meanwhile, when a retrieval target program is abstracted, an item name, commands, the execution conditions of commands, etc. need to be extracted from the program. The extraction of these items can be materialized using the publicly-known retrieval methods of a source code. For example, in Japanese Patent Official Gazette No. 3377836, a method of extracting an item name, a command sentence, a simple condition of a command and a complex condition of a command, etc. from a source program is described. By using the publicly known method, the item name, variable name, command sentence, conditional statement, etc. of a retrieval target program can be extracted. Then, the extracted item name, command sentence, execution condition, etc. can only be abstracted based on the above-mentioned abstraction level.

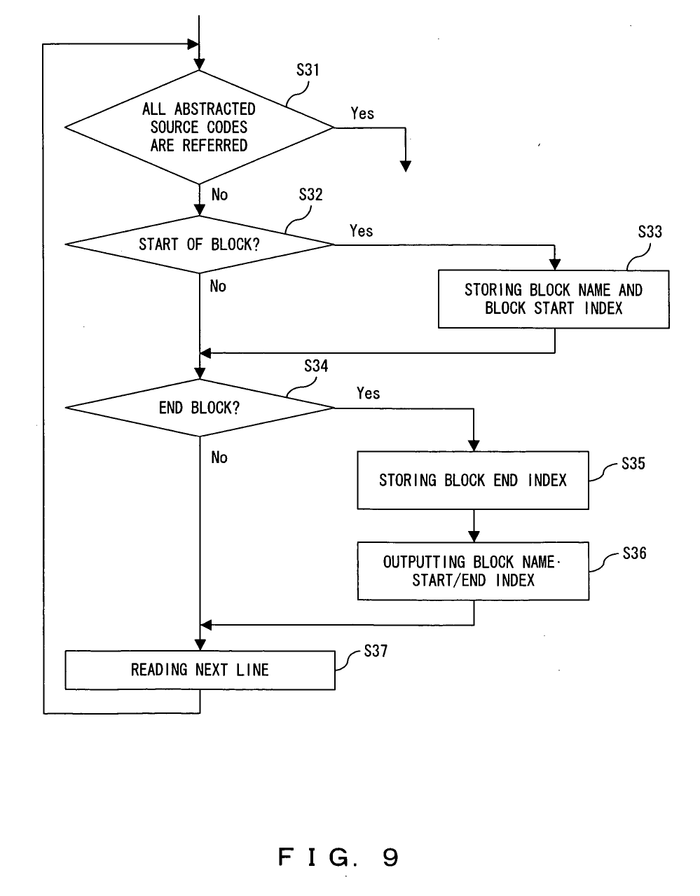

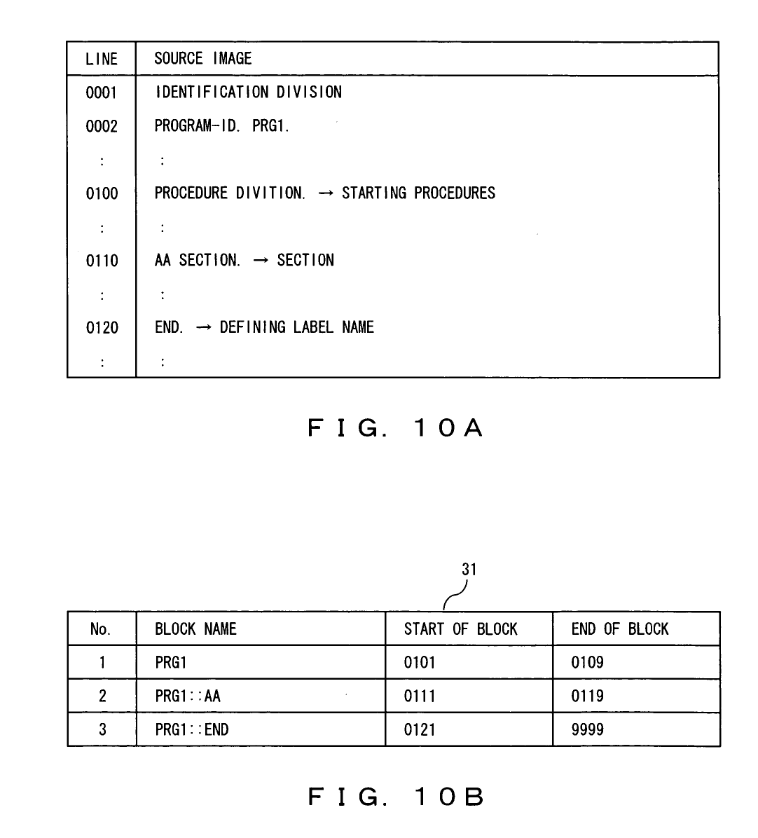

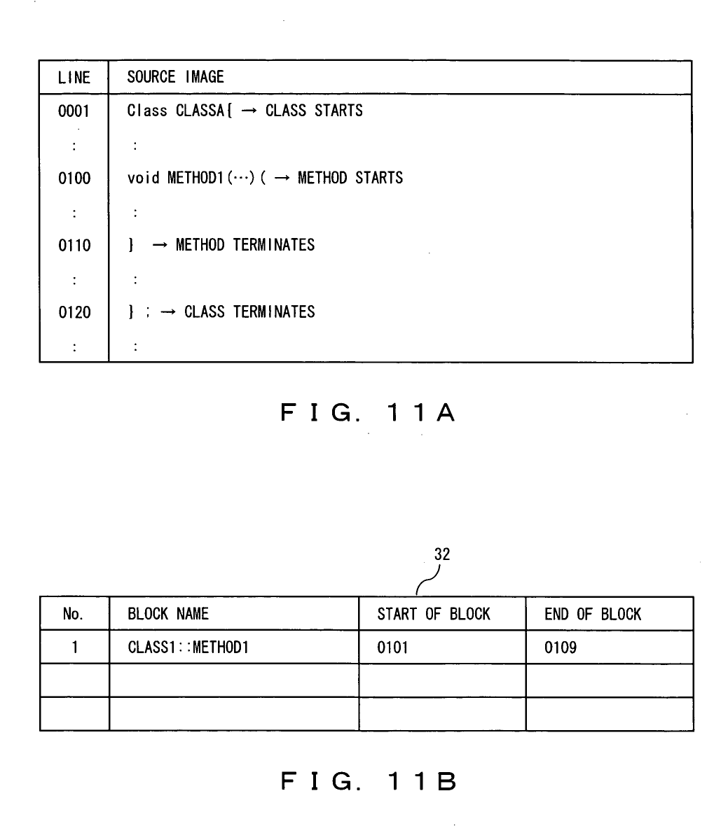

Then, the processing of dividing the abstracted retrieval target program into blocks is explained in reference to the flowchart of FIG. 9, and FIGS. 10 and 11.

In a method of dividing a program into blocks that is explained below, as for a structured program, a source code put among a procedure start, a section definition or a label name definition as shown in FIG. 10 is extracted as one block. Then, a block index table 31 that indicates the start address and the end address of each block is prepared.

In FIG. 9, it is determined whether or not all the abstracted source codes are referred to (S31). In the case where the abstracted source code that is not referred to exists (S31, NO), a process advances to step S32 and it is determined whether or not the source code is the start of a block. If the abstracted source code is the start of a block (S32, YES), a process advances to step S33, and the block name and the block start index are stored in a register, etc.

On the other hand, if the abstracted source code is not the start of a block (S32, NO), a process advances to step S34 and it is determined whether or not the source code is the end of a block.

If the abstracted source code is the end of a block (S34, YES), a process advances to step S35 and the block end index is stored in a register etc. Furthermore, in the next step S36, the block name and the start/end index are output. In this way, for example, the block name, the start of a block and end addresses are stored in the block index table 31.

In the case where it is determined that the source code is not the end of a block in step S34 (S34, NO), a process advances to step S37, the abstracted source code in the next line is read in and a process returns to step S31. Furthermore, in the case where it is determined in step S31 that all the abstracted source codes are referred to (S31, YES), the blocking processing terminates.

Each block, for example, the block of procedure start sentences denominates a “program name” as a block name, the block of section definitions denominates “program name::section name” as a block name and the block of section names and label name definitions denominates “program name label name” as a block name.

The block index table 31 of FIG. 10B shows a table of indexes of a block which is prepared from the program of FIG. 10A. For example, a code that is put between the procedure start sentence of a line number 100 “PROCEDURE DIVITION” and the section sentence of a line number 0110 “AASECTION” are retrieved as one block PRG1. Then, a line number “0101” following the procedure start line is set as the start address of the block and a line number “0109” immediately before the section AASECTION is set as the end address of the block.

As for the object-oriented program, the source code that is put between a method start sentence “{” and a method end sentence “}” as shown in FIGS. 11A and 11B is retrieved as a block. Then, the number of lines at the start and the end of a block is obtained, and a block index table 32 is prepared. As a block name, “class name method name” is denominated.

The block index table 32 of FIG. 11B shows the block index prepared by the program of FIG. 11A. A line number “0101” following the method start line is set as a block start address while a line number “0109” before the method end line is set as a block end address.

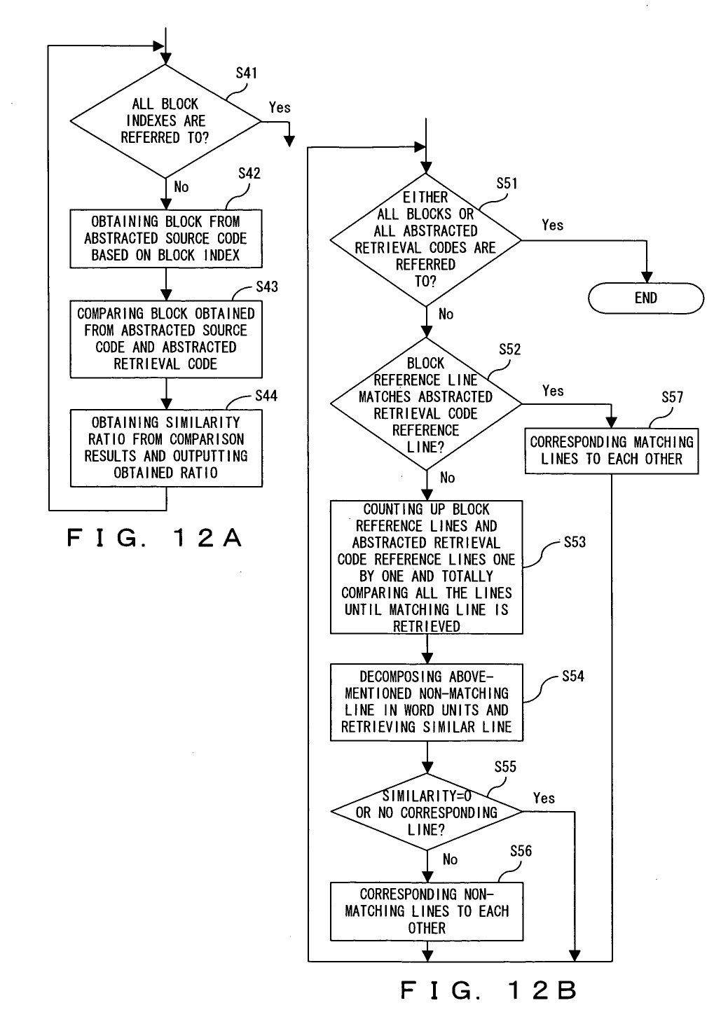

Then, the processing of comparing the thus-blocked retrieval target program and the reference source code in block units is explained in reference to the flowchart of FIG. 12.

It is determined whether or not all the prepared block index tables 31 and 32 are referred to (FIG. 12A, S41).

In the case where the reference of block indexes is not terminated (S41, NO), a process advances to step S42 and a block is obtained from the abstracted source code (source code of the abstracted retrieval target program) on the basis of block indexes.

Then, the comparison between a block obtained from the abstracted source code and the abstracted retrieval code (code obtained by abstracting a retrieval source code) is performed (S43).

After that, the similarity ratios between the two in line units and block units are calculated using the comparison results and the similarity ratios are outputted (S44).

Here, the comparison processing of codes in block units in step S43 of FIG. 12A is explained in reference to the flowchart of FIG. 12B.

At first, it is determined whether either all the obtained blocks or all the abstracted retrieval codes are referred to (FIG. 12B, S51).

In the case where the block or the abstracted retrieval code that is not referred to exists (S51, NO), a process advances to step S52 and it is determined whether a reference line of the block and a reference line of the abstracted retrieval code match to each other.

In the case where the codes do not match (S52, NO), a process advances to step S53. Then, all the reference lines of the block and all the reference lines of the abstracted retrieval code are counted up and they are totally compared one by one until a matching line is retrieved (S53).

Then, lines that do not match are disassembled to be compared in word units (S54). After that, it is determined whether or not the similarity degree is 0 or whether or not the correspondence line exists between a reference line of the block and a reference line of the abstracted retrieval code (S55).

In the case where the similar word exists or the correspondence line exists (S55, NO), a process advances to step S56, lines that do not match to each other are corresponded and a process returns to step S51. In the case where neither similar word nor correspondence line exists (S55, YES), a process returns to step S51.

In step S52, in the case where the block reference line and the abstracted retrieval code reference line match to each other (S52, YES), a process advances to step S57 and the matched lines are corresponded.

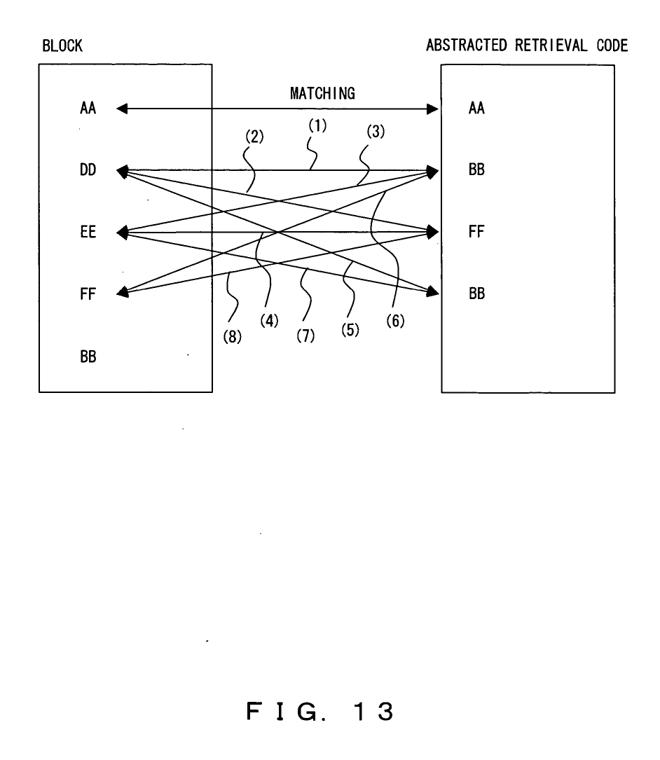

Here, the comparison of codes in block units is explained in reference to FIG. 13.

When the codes in a start line of the block obtained from the abstracted retrieval target program (hereinafter, referred to as only a block) and the code in a start line of the abstracted retrieval code are compared, they match to each other at “AA”.

Then, when codes in the second line are compared, they do not match (FIG. 12, (1)), so that the second line is compared with the third line of the abstracted retrieval code (FIG. 12 (2)). These lines do not match so that the second line of the abstracted retrieval code is compared with the third line of the block (FIG. 12, (3)).

Since these lines do not match, the third line of the block is compared with the third line of the abstracted retrieval code (FIG. 12, (4)). Since these lines do not match, the second line of the block is compared with the fourth line of the abstracted retrieval code (FIG. 12, (5)).

Since these lines do not match, the second line of the abstracted retrieval code is compared with the forth line of the block (FIG. 12, (6)). Since these lines do not match, the third line of the block is compared with the forth line of the abstracted retrieval code (FIG. 12, (7)).

Since these lines do not match, the third line of the abstracted retrieval code is compared with the forth line of the block (FIG. 12, (8)). Since these lines match, it is detected that the forth line of the block matches the third line of the abstracted retrieval code, and the second and third lines of the block have no correspondence line.

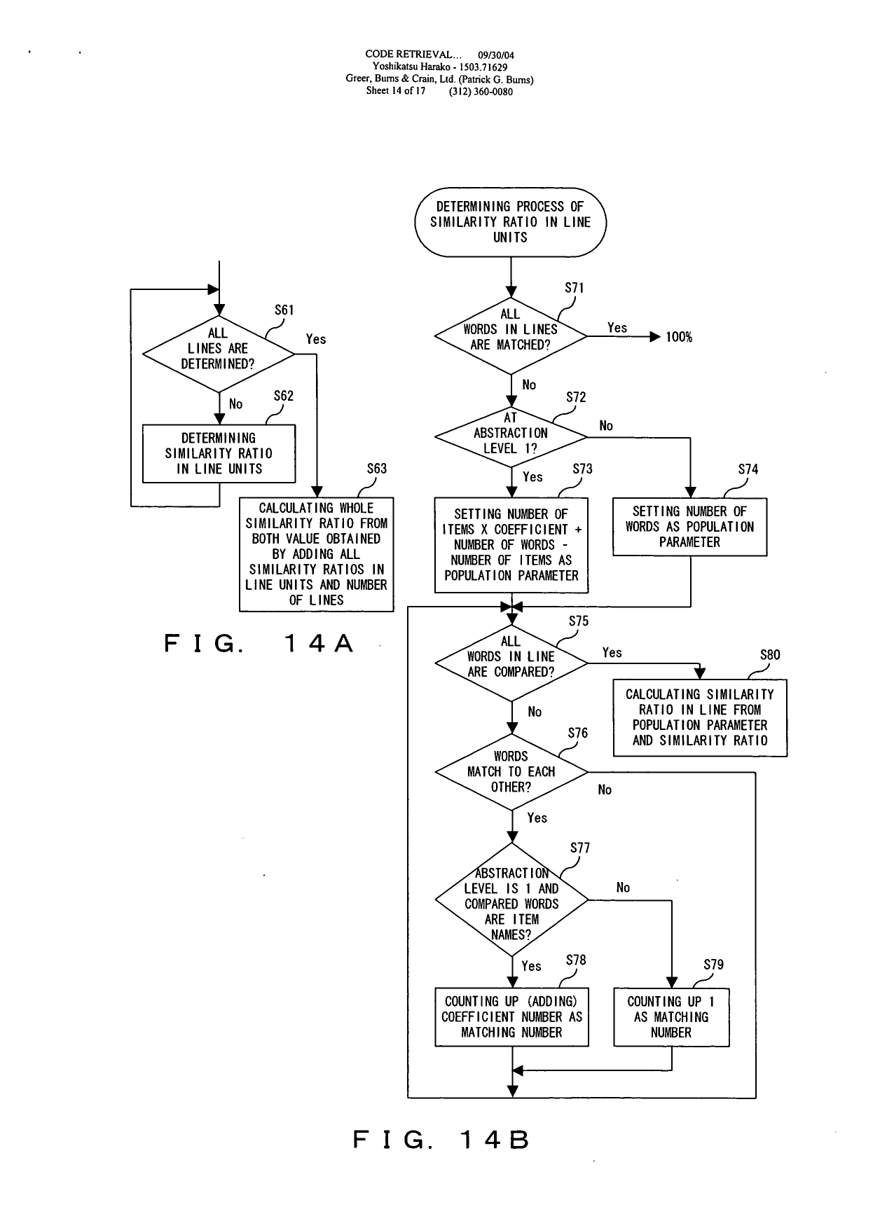

Then, the details of a calculation processing of the similarity ratio in step S44 of FIG. 12A is explained in reference to the flowchart of FIG. 14.

First of all, it is determined whether or not the comparison between all the lines of the abstracted retrieval target program and the abstracted retrieval code terminates (FIG. 14A, S61).

In the case where the comparison does not terminate (S61, NO), a process advances to S62 and the similarity ratio is determined in line units.

Here, the processing of determining a similarity ratio in line units in step S62 is explained in reference to the flowchart of FIG. 14B.

At first, it is determined whether or not all the words both in the specific line of a block of the retrieval target program and in lines of the abstracted retrieval code match to each other (FIG. 14B, S71).

In the case where words that do not match exist, that is, the comparison is not an exact match (S71, NO), a process advances to step S72 and it is determined whether or not the retrieval target program is abstracted at the abstraction level 1.

In the case where the program is abstracted at the abstraction level 1 (S72, YES), a process advances to step S73. In this step, the number of items that exist in a certain line is multiplied by the predetermined coefficient, the number of words in the line is added to the thus-multiplied number. Furthermore, the thus-added number is subtracted by the number of items and thus-subtracted number is set as the value of a denominator (population parameter).

On the other hand, if the abstraction level is not the level 1 (S72, NO), a process advances to step S74 and the number of words in a certain line is set as the value of a denominator.

Following steps S73 or S74, a process advances to step S75 and it is determined whether or not the comparison for all the words in the line terminates.

In the case where the comparison of all the words in the line does not terminate (S75, NO), a process advances to step S76 and it is determined whether or not the next word matches the corresponding word of the abstracted retrieval code.

In the case where the two words match to each other (S76, YES), it is determined whether or not the abstraction is performed at the abstraction level 1 and the compared words are item names (variable names) (S77).

In the case where the abstraction is performed at the abstraction level 1 and the compared words are item names (S77, YES), a process advances to step S78 and the coefficient (number that is multiplied by the number of items when calculating a denominator) is added as a matching number.

According to the above-mentioned processing, in the case where the abstraction is performed at the abstraction level 1, the matching number when item names match becomes large by the value of the coefficient. Since the matching of item names is important in the retrieval performed at the abstraction level 1 so that the similarity ratio is made high in the case where item names match in the calculation processing of a similarity ratio, which is performed later.

In the case where the abstraction level is not the level 1 or the matched word is not an item name in step S77 (S77, NO), a process advances to step S79 and [1] is counted up as a matching number.

In step S75, in the case where the comparison of all the words in a line terminates (S75, YES), a process advances to step S80 and the similarity ratio in a line is calculated from the value of the denominator and the matching number that are obtained by the previous processings.

In the case where the similarity ratio in each line is thus calculated and it is determined in step S61 that the calculation of all the similarity ratios of the whole block terminates (S61, YES), a process advances to step S63 and a similarity ratio in block units is calculated from the value obtained by adding all the similarity ratios in line units and the number of lines.

According to the above-mentioned processings, the similarity ratio between the abstracted retrieval code and each line of the compared block and the similarity ratio of the whole block can be obtained.

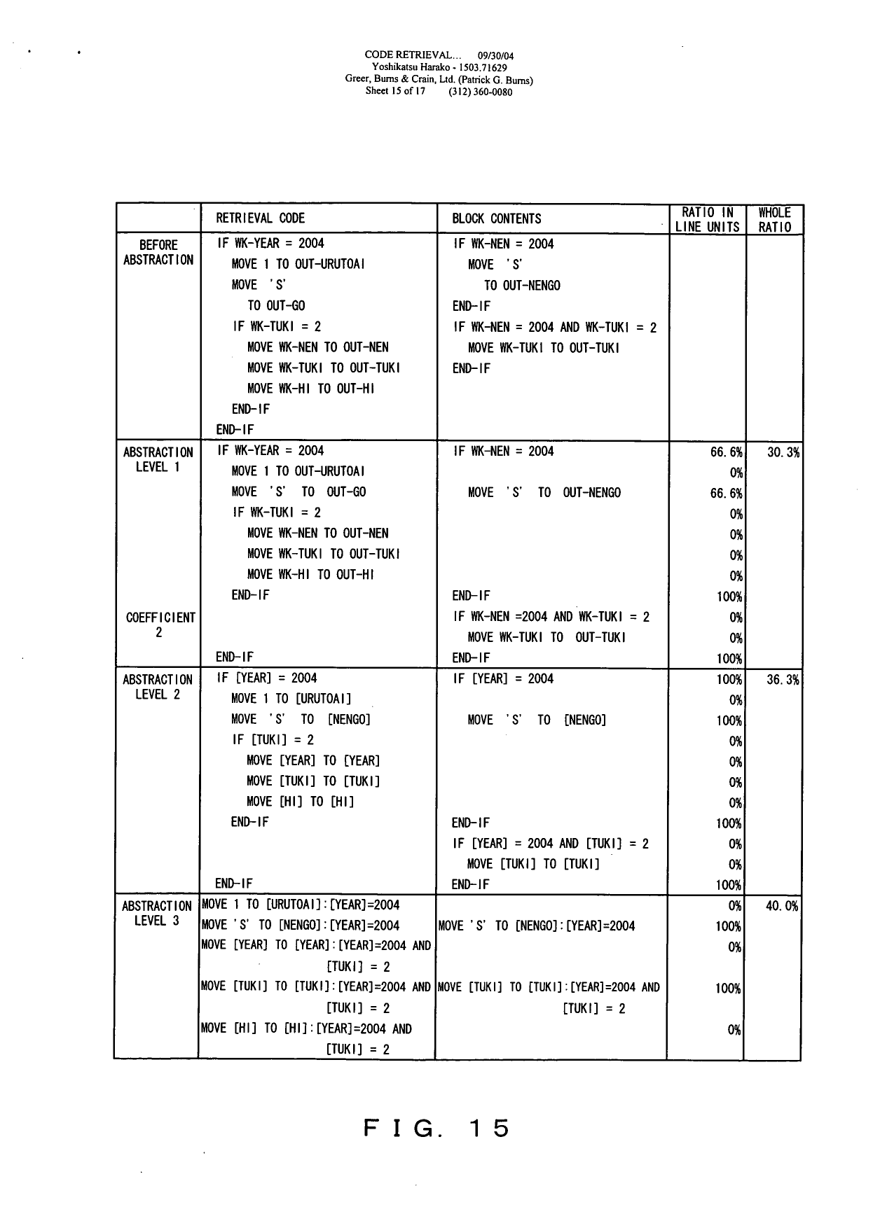

FIG. 15 shows the calculation results of the similarity ratios in the case where a retrieval code (retrieval source code) and one block of a retrieval target program are respectively abstracted at the abstraction level 1, the abstraction level 2 and the abstraction level 3.

When the retrieval code and retrieval target block before abstraction that are shown in FIG. 15 are abstracted at the abstraction level 1, the command is changed to normalization expression as shown in FIG. 15.

Since the item name in this case is not changed, regarding “IF WK-YEAR=2004” in the first line of the retrieval code and “IF WK-NEN=2004” in the first line of the retrieval target block, the item name of the former “WK-YEAR” is different from that of the latter “WK-NEN”. Therefore, the similarity ratio becomes 66.6% using the above-mentioned similarity ratio calculation processing.

Similarly, an item name “OUT-GO” in the third line of the retrieval code and an item name “OUT-NENGO in the third line of the retrieval target block” are different so that the similarity ratio becomes 66.6%.

The similarity ratio of the whole retrieval target block becomes 30.3% using an equation of (66.6+66.6+100+100)÷11.

When the same retrieval code and retrieval target block are abstracted at the abstraction level 2, the command in the first line of the retrieval code and that in the first line of the retrieval target block become “IF [YEAR]=2004”, which shows that the two match to each other. Therefore, the similarity ratio becomes 100%. Similarly, the similarity ratio becomes 100% in the third line. Accordingly, the similarity ratio of the whole block becomes 36.3%.

When the same retrieval code and retrieval target block are abstracted at the abstraction level 3, the conditional statement of the retrieval code is abstracted, the item name is further abstracted and “MOVE 1 TO [URUTOAI]:[YEAR]=2004” is described in the first line. The second line becomes “MOVE ‘S’ TO [NENGO]:[YEAR]=2004”.

On the other hand, since the second line becomes “MOVE ‘S’ TO [NENGO]:[YEAR]=2004 regarding the retrieval target block, all the codes in the second line of the retrieval code and in the second line of the retrieval target block fully match to each other so that the similarity ratio in the second line becomes 100%.

In this case, since there is no conditional statement, the number of lines of the retrieval code becomes five and the value obtained by adding the similarity ratio in line units becomes 200% so that the whole similarity ratio becomes 40%.

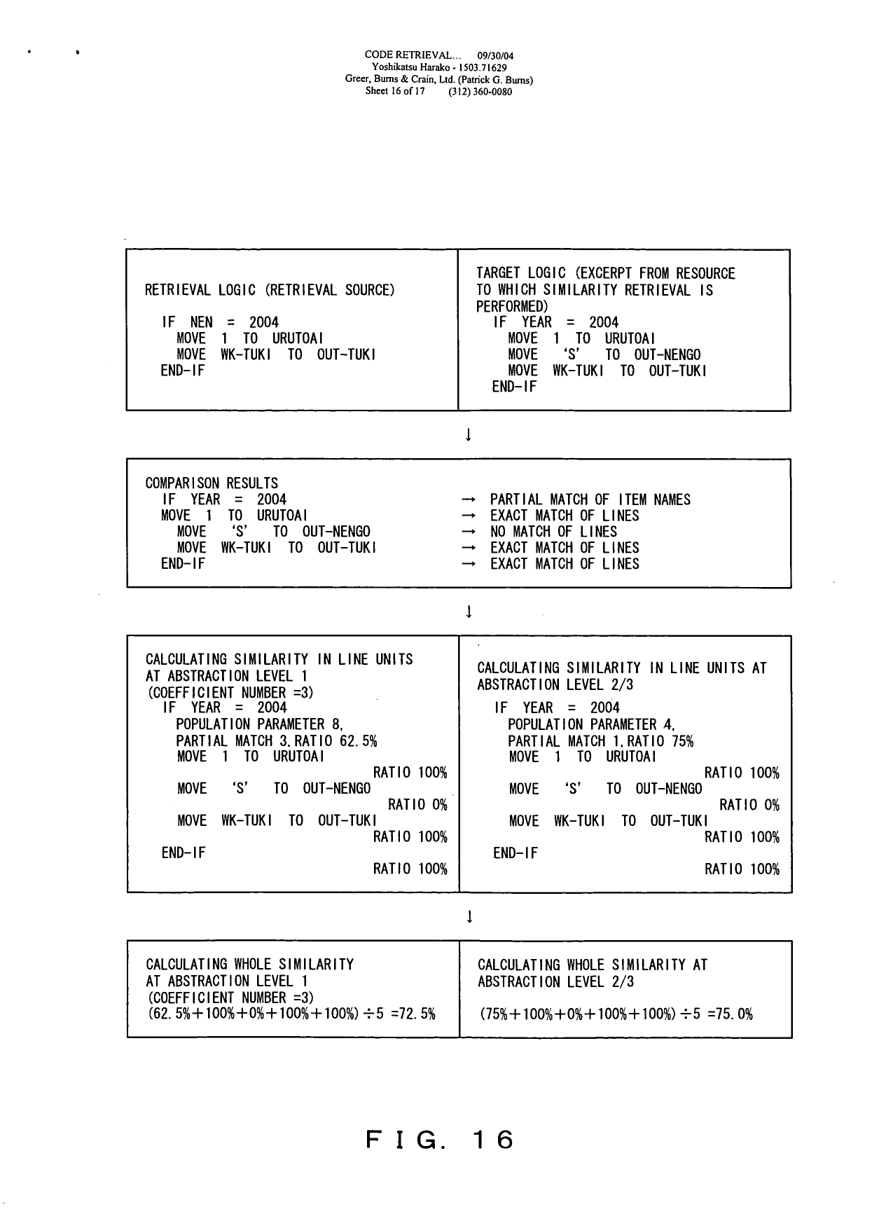

Here, the similarity ratio calculation method in the case of the abstraction level 1 is explained in detail in reference to FIG. 16.

When the retrieval logic (retrieval source code) and the code obtained by abstracting target logic (block obtained from the retrieval target program) as shown in FIG. 16 are compared at the abstraction level 1, the first line of the target logic is a partial match of item names, the second line is an exact match, the third line is no match and each of the fourth and fifth lines is an exact match.

In this case, if the coefficient of an item is “3”, the number of words is four and the number of items is two (in this case, “YEAR” and “2004” are item names) in the first line. Accordingly, the value of the denominator becomes “2×3+4−2=8”. Since the number of matching items is one, the matching number is “5” and the similarity ratio becomes 62.5% in the first line.

Since all the commands and item names of retrieval logic and target logic match to each other in the second line, the similarity ratio becomes 100%. In the third line, the comparison is no match so that the similarity ratio is 0%. Furthermore, the comparison is an exact match in each of the fourth and fifth lines so that the similarity ratio becomes 100%.

Accordingly, the similarity ratio of the whole block of the target logic becomes (62.5%+100%+0%+100%+100%)÷5=72.5%.

In addition, in the case where the same target logic is abstracted at the abstraction level 2, the first line of the retrieval logic and an item name “YEAR” in the first line of the target logic do not match as shown in FIG. 16. In the first line, the number of words becomes four, the matching number is “3” and the similarity ratio becomes 75%. The similarity ratios in and subsequent the second line are the same as those at the abstraction level 1.

Accordingly, the similarity ratio of the whole block in this case becomes (75%+100%+0%+100%+100%)÷5=75.0%.

According to the above-mentioned preferred embodiment, an abstraction level is determined based on either the modification management information 11 showing the modification contents of a retrieval source code or the system structure information 12 showing the system structure of a grogram to which modification is added and the position on a system structure of the modification part. Then, a retrieval target program and a retrieval source code are abstracted based on the abstraction level to be compared and the similarity ratio is calculated.

Thus, all the codes obtained by copying a retrieval source code that exists in the retrieval target program can be retrieved. Furthermore, since the copied codes can be automatically retrieved, variations of retrieval accuracy caused by skills of each person does not occur, which is different from a method of retrieving codes by inputting a retrieval character string by a person.

In addition, an abstraction level suitable for the structure of a program can be set by determining an abstraction level based on the system structure information 12. In this way, precise retrieval can be realized in accordance with the current status.

Since the code similar to a retrieval source code can be retrieved by calculating the similarity ratio, codes in which same obstacles may occur can be retrieved in advance and they can be maintained in order to prevent the occurrence of the obstacle by retrieving such codes based on obstacle information.

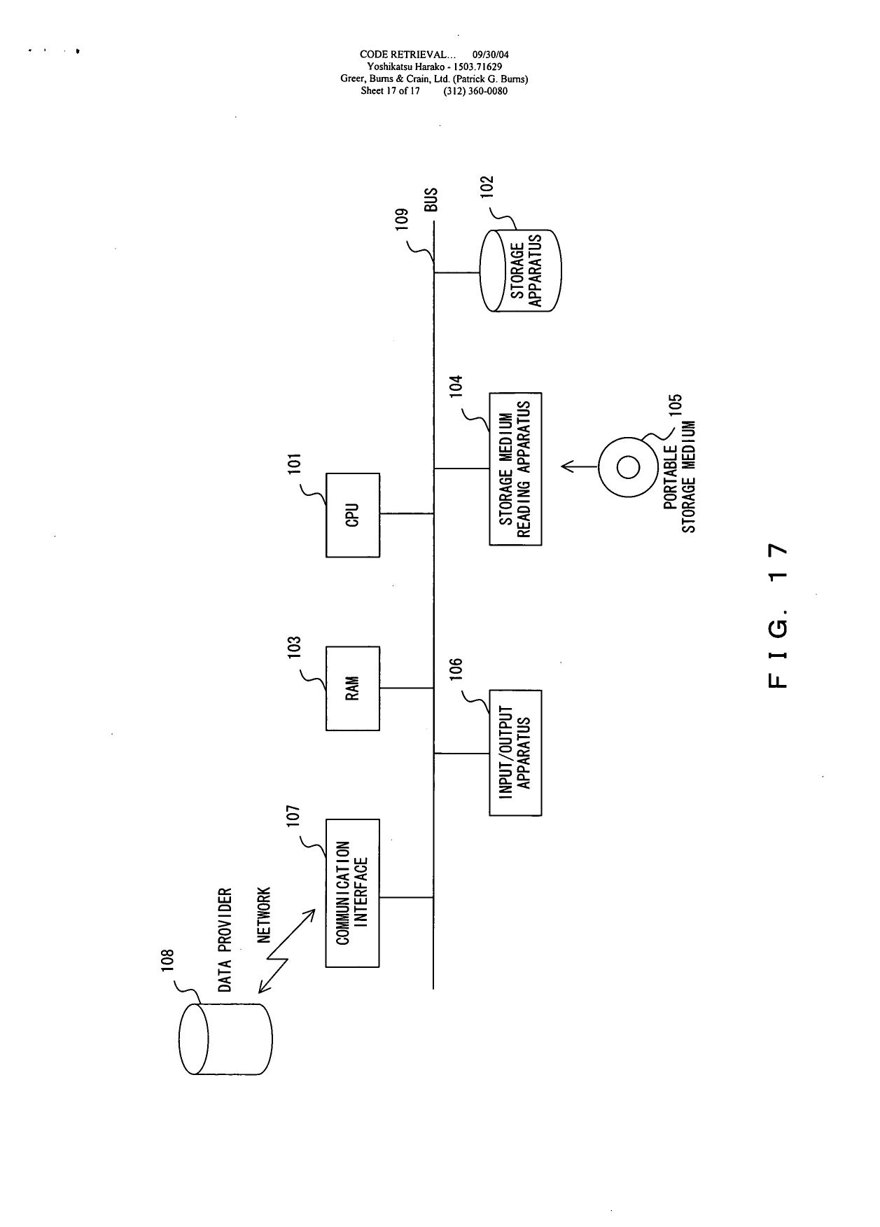

Then, one example of the hardware structure of the data processing apparatus that is used as a code retrieval apparatus of the preferred embodiment is explained in reference to FIG. 17.

In an external storage apparatus 102, a program such as a similarity retrieval tool etc. of the present preferred embodiment, the modification information management table 21, the system structure information table 22, etc. are stored.

A CPU101 reads out the program that is stored in the external storage apparatus 102 and implements the above-mentioned retrieval target program, the abstraction processing of a retrieval source code, a similarity ratio calculation processing, etc.

An RAM 103 is used as a region for temporarily storing data or the various types of registers that are used for computation.

A storage medium reading apparatus 104 is used for reading or writing a portable storage medium 105 such as a CDROM, a DVD, a flexible disk, an IC card, etc. The code retrieval program of the preferred embodiment is stored in the portable storage medium 105 and the program maybe loaded into the external storage apparatus 102.

An input apparatus 106 inputs data using a keyboard, etc. A communication interface 107 is connected to a network such as a LAN, the Internet, etc. and it can download data, a program, etc. from a server 108, etc. of a data provider through a network. Meanwhile, the CPU101, the external storage apparatus 102, the RAM103, etc. are connected by a bus 109.

The present invention is not limited to the above-mentioned preferred embodiment and it can be configured, for example, as follows:

(1) The number of abstraction levels is not limited to three and the number may be two or four or more in accordance with the target program. As for the standard at the time of performing abstraction, the abstraction may be performed based on not only an item name/variable name, other than the condition of a command and an execution condition but also other elements.

(2) The modification management information 11 and the system structure information 12 are not limited to a step of being stored in a table in advance and a user may input these pieces of information when a similarity retrieval tool is implemented.

(3) The output of a similarity degree is not limited to a step of displaying it with a percent. For example, the similarity degree is displayed in such a way that the difference of the similarity degrees can be recognized using a character and a diagram or the similarity degree may be outputted by the other means. Alternatively, a code of which the similarity degree is equal to or larger than a fixed value is displayed as a retrieval result without displaying the similarity degree.

According to the present invention, by comparing a retrieval target program and a retrieval source code that are abstracted based on modification contents or the system configuration of a program and by calculating the similarity degree between the two, the code related to a retrieval source code that exists in a retrieval target program can be retrieved.

1. A code retrieval method of retrieving a code related to a retrieval source code from a retrieval target program, comprising:
determining an abstraction level of a retrieval condition based on at least either modification contents for the retrieval source code or system structure information about a system structure of a program including the retrieval source code;
abstracting the retrieval target program and the retrieval source code based on the determined abstraction level;
comparing the abstracted retrieval target program and retrieval source code, thereby calculating a similarity degree of the codes; and
outputting a code having a high similarity degree in the retrieval target program.

2. The code retrieval method according to claim 1, wherein
when an abstraction level is determined, it is determined by stored information or inputted information which one of three changes such as a change of an item name or a variable name, a change other than a condition of a command and a change of a condition of a command, modification contents for the retrieval source code correspond to, thereby determining an abstraction level based on the determination results.

3. The code retrieval method according to claim 1, wherein
when an abstraction level is determined, the abstraction level is determined based on modification management information about modification contents of the retrieval source code and the system structure information about a system structure of a program including the retrieval source code.

4. The code retrieval method according to claim 1, wherein
when an abstraction level is determined, the abstraction level is determined based on information about a programming method of preparing a program including the retrieval source code and information about a position on a hierarchy in a system structure of the retrieval source code.

5. A code retrieval apparatus for retrieving a code related to a retrieval source code from a retrieval target program, comprising:
an abstraction level determining unit determining an abstraction level of a retrieval condition based on at least either modification contents for the retrieval source code or system structure information about a system structure of a program including the retrieval source code;
an abstracting unit abstracting the retrieval target program and the retrieval source code based on the abstraction level determined by the abstraction level determining unit;
a similarity degree calculating unit comparing the retrieval target program and the retrieval source code that are abstracted by the abstracting unit and calculating a similarity degree of the codes; and
an outputting unit outputting a code having a high similarity degree calculated by the similarity degree calculating unit.

6. The code retrieval apparatus according to claim 5, wherein
the abstraction level determining unit determines which one of three changes such as a change of an item name or a variable name, a change other than a condition of a command and a change of a condition of a command, the modification contents for the retrieval source code correspond to, thereby determining an abstraction level based on the determination results.

7. The code retrieval apparatus according to claim 5, wherein
the abstraction level determining unit determines an abstraction level based on modification management information about modification contents of the retrieval source code and the system structure information about a system structure of a program including the retrieval source code.

8. The code retrieval apparatus according to claim 5, wherein
the abstraction level determining unit determines an abstraction level based on a programming method of preparing a program including at least the retrieval source code and information about a position on a hierarchy in a system structure of the retrieval source code.

9. The code retrieval apparatus according to claim 5, wherein
the abstracting unit comprises a dividing unit dividing the retrieval target program into block units; and the similarity degree calculating unit compares respective lines of a block including the retrieval source codes and a block of the retrieval target programs, thereby calculating a similarity degree of respective lines and a similarity degree in block units.

10. The code retrieval apparatus according to claim 5, wherein
the abstraction level determining unit determines whether or not the retrieval source code is a common module that is commonly used in a program and sets the abstraction level low in a case where the retrieval source code is the common module.

11. The code retrieval apparatus according to claim 5, wherein
the abstraction level determining unit determines whether or not a program in which the retrieval source code exists is a structured program, determines whether a hierarchy on which the retrieval source code exists is a high-level hierarchy or a low-level hierarchy and sets an abstraction level of a retrieval condition low in a case where the retrieval source code exists on the low-level hierarchy while setting an abstraction level higher than the abstraction level at the time of the low-level hierarchy in a case where the retrieval source code exists on the high-level hierarchy.

12. The code retrieval apparatus according to claim 5, wherein
the abstraction level determining unit determines whether or not a program in which the retrieval source code exists is an object-oriented program, determines whether a hierarchy on which the retrieval source code exists is a high-level hierarchy, an intermediate-level hierarchy or a low-level hierarchy and sets an abstraction level low in a case where the retrieval source code exists on the high-level hierarchy while setting an abstraction level higher than the abstraction level at the time of the high-level hierarchy in a case where the retrieval source code exists on the intermediate-level hierarchy or the low-level hierarchy.

13. The code retrieval apparatus according to claim 5, wherein
the similarity degree calculating unit changes a coefficient for calculating a similarity degree in accordance with the abstraction level.

14. A computer-readable storage medium storing a code retrieval program for retrieving a code related to a retrieval source code from a retrieval target program, said code retrieval program
determines an abstraction level of a retrieval condition based on at least either modification contents for the retrieval source code or system structure information about a system structure of a program including the retrieval source code;
abstracts the retrieval target program and the retrieval source code based on the determined abstraction level;
compares the abstracted retrieval target program and retrieval source code and calculates a similarity degree of the codes; and
outputs a code having a high similarity degree in the retrieval target program.

15. The storage medium according to claim 14, wherein
when an abstraction level is determined, it is determined by stored information or inputted information which one of three changes such as of a change of an item name or a variable name, a change other than a condition of a command and a change of a condition of a command, modification contents for the retrieval source code correspond to, thereby determining an abstraction level based on the determination results.

16. The storage medium according to claim 14, wherein
when an abstraction level is determined, the abstraction level is determined based on modification management information about modification contents of the retrieval source code and system structure information about a system structure of a program including the retrieval source code.

17. The storage medium according to claim 14, wherein
when an abstraction level is determined, the abstraction level is determined based on information about a programming method of preparing a program including at least the retrieval source code and information about a position on a hierarchy in a system structure of the retrieval source code.

18. The storage medium according to claim 14, wherein
when the retrieval target program is divided into block units and a similarity degree is calculated, respective lines of a block including the retrieval source code and a block of the retrieval target program are compared, thereby calculating a similarity degree of respective lines and a similarity degree in block units.

19. The storage medium according to claim 14, wherein
when an abstraction level is determined, it is determined whether or not the retrieval source code is a common module that is commonly used in a program and the abstraction level is set low in a case where the retrieval source code is the common module.

20. The storage medium according to claim 14, wherein
when an abstraction level is determined, it is determined whether or not a program in which the retrieval source code exists is a structured program and whether a hierarchy on which the retrieval source code exists is a high-level hierarchy or a low-level hierarchy and an abstraction level of a retrieval condition is set low in a case where the retrieval source code exists on the low-level hierarchy while setting an abstraction level higher than the abstraction level at the time of the low-level hierarchy in a case where the retrieval source code exists on the high-level hierarchy.

21. The storage medium according to claim 14, wherein
a coefficient for calculating a similarity degree is changed in accordance with an abstraction level.

22. A computer data signal that is realized by a Carrier signal and offers a code retrieval program for retrieving a code related to a retrieval source code from a retrieval target program, wherein the code retrieval program
determining an abstraction level of a retrieval condition based on at least either modification contents for the retrieval source code or system structure information about a system structure of a program including the retrieval source code;
abstracting the retrieval target program and the retrieval source code based on the determined abstraction level;
comparing the abstracted retrieval target program and retrieval source code, thereby calculating a similarity degree of the codes; and
outputting a code with a high similarity degree in the retrieval target program.

23. The computer data signal according to claim 22, wherein
when an abstraction level is determined, it is determined by stored information or inputted information which one of three changes such as a change of an item name or a variable name, a change other than a condition of a command and a change of a condition of a command, modification contents for the retrieval source code correspond to, thereby determining an abstraction level based on the determination results.
